(19) United States
(12) Patent Application Publication
(10) Pub. No.: US 2013/0135396 A1
(43) Pub. Date: May 30, 2013

(54) INKJET PRINT HEAD

(71) Applicants: Jae Chang Lee, Osan (KR); Tae Kyung Lee, Suwon (KR); Hwa Sun Lee, Hwaseong (KR)

(72) Inventors: Jae Chang Lee, Osan (KR); Tae Kyung Lee, Suwon (KR); Hwa Sun Lee, Hwaseong (KR)

(73) Assignee: Samsung Electro-Mechanics, Suwon (KR)

(21) Appl. No.: 13/584,009

(22) Filed: Aug. 13, 2012

(30) Foreign Application Priority Data
Nov. 30, 2011 (KR) 10-2011-0126593

(51) Int. Cl. B41J 2/04

(52) U.S. Cl. 347/54

(57) ABSTRACT

There is provided an inkjet print head, including: a first substrate in which a first restrictor and a pressure chamber are formed; and a second substrate in which a manifold, a second restrictor, and a nozzle are formed, wherein the first restrictor is connected to the manifold and the second restrictor, and the second restrictor is connected to the first restrictor and the pressure chamber.

### CROSS-REFERENCE TO RELATED APPLICATIONS

This application claims the priority of Korean Patent Application No. 10-2011-0126593 filed on Nov. 30, 2011, in the Korean Intellectual Property Office, the disclosure of which is incorporated herein by reference.

### BACKGROUND OF THE INVENTION

1. Field of the Invention

The present invention relates to an inkjet print head, and more particularly, to an inkjet print head in which ink flow back, occurring during an ejection of ink, is effectively reduced.

2. Description of the Related Art

An inkjet print head is an apparatus for converting an electrical signal into a physical impulse and ejecting droplets of stored ink.

As an inkjet print head may be manufactured in mass production, it is used not only for printers for office but also for industrial printers. For example, the inkjet print head is used not only in offices for printing out documents by ejecting ink on paper but also in factories where circuit patterns are produced directly by ejecting a liquid metal material to a printed circuit board (PCB).

A general inkjet print head may include a plurality of pressure chambers and a plurality of nozzles. The inkjet print head may simultaneously eject monochromatic ink or multiple colors of ink through the plurality of nozzles, thereby not only increasing a printing speed thereof but also enabling vivid printing.

However, in the above-described inkjet print head structure, intervals between the pressure chambers are very small, and thus crosstalk, in which ejection pressure formed in a predetermined pressure chamber affects a neighboring pressure chamber, is likely to occur.

Thus, an inkjet print head capable of providing not only high speed and vivid printing but also a reduction in crosstalk is required.

### SUMMARY OF THE INVENTION

An aspect of the present invention provides an inkjet print head allowing for high speed printing, vivid printing and a reduction in crosstalk.

According to an aspect of the present invention, there is provided an inkjet print head, including: a first substrate in which a first restrictor and a pressure chamber are formed; and a second substrate in which a manifold, a second restrictor, and a nozzle are formed, wherein the first restrictor is connected to the manifold and the second restrictor, and the second restrictor is connected to the first restrictor and the pressure chamber.

The first restrictor may have a greater length than the second restrictor.

The first restrictor may have a greater width than the second restrictor.

The first restrictor and the second restrictor may have smaller widths than the pressure chamber.

When the first substrate and the second substrate are coupled to each other, a first area in which the first restrictor and the manifold overlap each other may be greater than a second area in which the first restrictor and the second restrictor overlap each other.

When the first substrate and the second substrate are coupled to each other, the second area may be smaller than a third area in which the second restrictor and the pressure chamber overlap each other.

When the first substrate and the second substrate are coupled to each other, a second area in which the first restrictor and the second restrictor overlap each other may be smaller than a third area in which the second restrictor and the pressure chamber overlap each other.

The first restrictor may have a greater volume than the second restrictor.

The second substrate may have a buffer space formed therein, the buffer space connecting the pressure chamber to the nozzle.

According to another aspect of the present invention, there is provided a an inkjet print head, including: a first substrate in which a manifold, a second restrictor, and a pressure chamber are formed; and a second substrate in which a first restrictor, a third restrictor, and a nozzle are formed, wherein the first restrictor is connected to the manifold and the second restrictor, and the third restrictor is connected to the second restrictor and the pressure chamber.

The first restrictor may have a greater length than the second restrictor.

The first restrictor may have a greater width than the second restrictor.

The first restrictor, the second restrictor, and the third restrictor may have smaller widths than the pressure chamber.

When the first substrate and the second substrate are coupled to each other, a first area in which the first restrictor and the manifold overlap each other may be greater than a second area in which the first restrictor and the second restrictor overlap each other.

When the first substrate and the second substrate are coupled to each other, the second area may be greater than a third area in which the second restrictor and the third restrictor overlap each other.

When the first substrate and the second substrate are coupled to each other, the first area may be greater than a fourth area in which the third restrictor and the pressure chamber overlap each other.

When the first substrate and the second substrate are coupled to each other, a second area in which the first restrictor and the second restrictor overlap each other or a third area in which the second restrictor and the third restrictor overlap each other may be smaller than a fourth area in which the third restrictor and the pressure chamber overlap each other.

The first restrictor may have a greater volume than the second restrictor or the third restrictor.

The third restrictor may have a greater volume than the second restrictor.

The second substrate may have a buffer space formed therein, the buffer space connecting the pressure chamber to the nozzle.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is an exploded perspective view of an inkjet print head according to an embodiment of the present invention;

FIG. 2 is a bottom view of a first substrate illustrated in FIG. 1;

FIG. 3 is a plan view of a second substrate illustrated in FIG. 1;

FIG. 4 is an assembled perspective view of the inkjet print head of FIG. 1;

FIG. 5 is a cross-sectional view of the inkjet print head of FIG. 4 taken along line A-A;

FIG. 6 is a view showing a coupling surface (cross-section B-B) of the inkjet print head of FIG. 5;

FIG. 7 is a cross-sectional view of an inkjet print head according to another embodiment of the present invention, taken along line A-A;

FIG. 8 is a view showing a coupling surface (cross-section B-B) of the inkjet print head of FIG. 7;

FIG. 9 is a cross-sectional view of an inkjet print head according to another embodiment of the present invention, taken along line A-A;

FIG. 10 is a view showing a coupling surface (cross-section B-B) of the inkjet print head of FIG. 9; and

FIG. 11 is an exploded perspective view of an inkjet print head according to another embodiment of the present invention.

### DETAILED DESCRIPTION OF THE EMBODIMENTS

Hereinafter, embodiments of the present invention will be described in detail with reference to the accompanying drawings.

In describing the present invention below, terms indicating components of the present invention are named in consideration of functions thereof. Therefore, the terms should not be understood as limiting the technical components of the present invention.

An inkjet print head may eject ink, stored in a pressure chamber, to the outside through a nozzle by using pressure generated by an actuator. Here, a significant amount of ink stored in the pressure chamber is ejected to the outside through the nozzle, while a certain amount thereof may flow back to a manifold.

This phenomenon causes ink supplied through the manifold to flow unstably, thereby deteriorating printing quality of the inkjet print head.

Meanwhile, the inkjet print head may be manufactured by stacking a plurality of substrates. In this structure, a manifold, a pressure chamber, and a nozzle, and the like may be separately arranged in the individual substrates, and thus manufacturing process may be simplified.

However, as printing apparatuses are becoming increasingly compact and thin, technology enabling the manufacturing of an inkjet print head with a small number of substrates is required.

To solve the above-described problem, an inkjet print head may be manufactured with a small number of substrates while minimizing ink flow back from a pressure chamber toward a manifold.

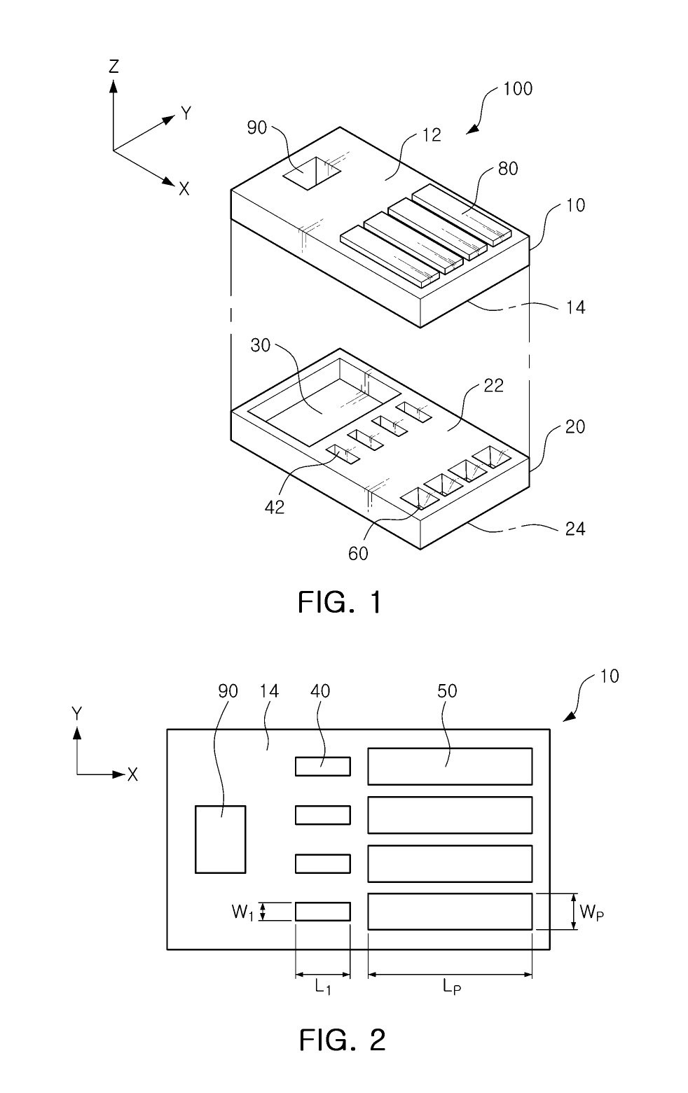

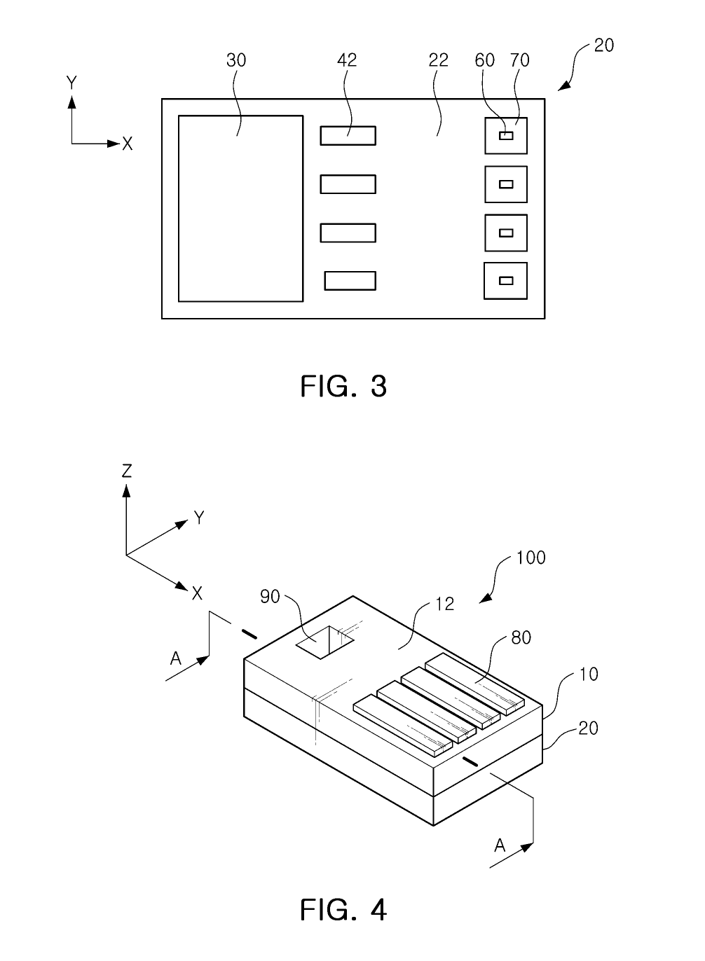

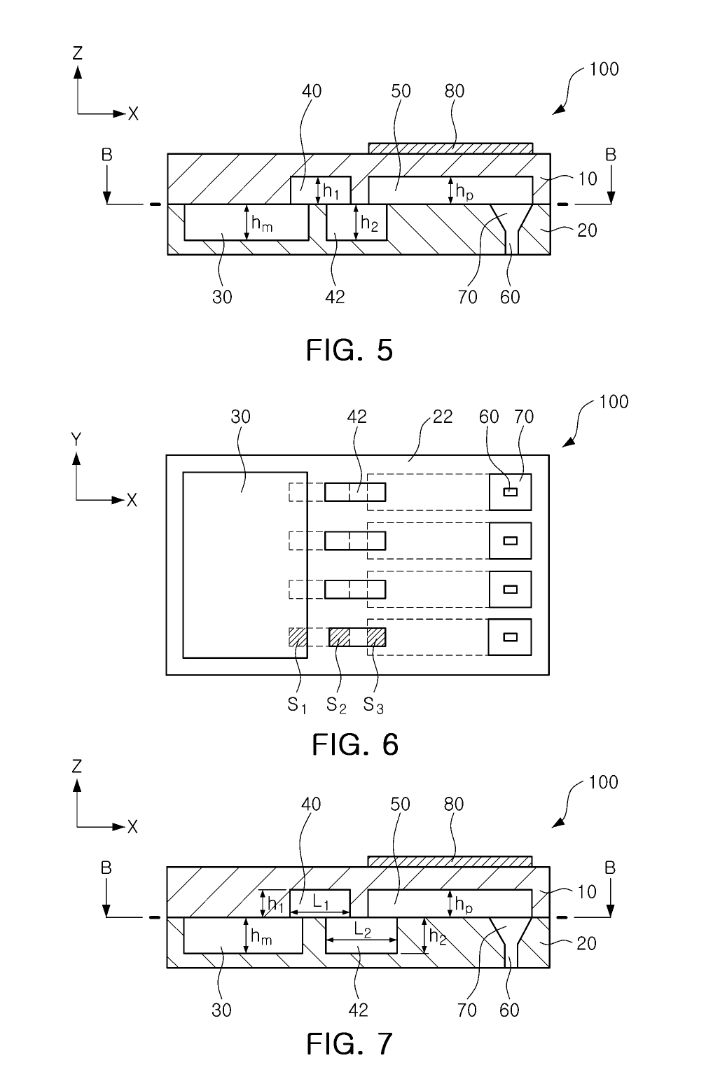

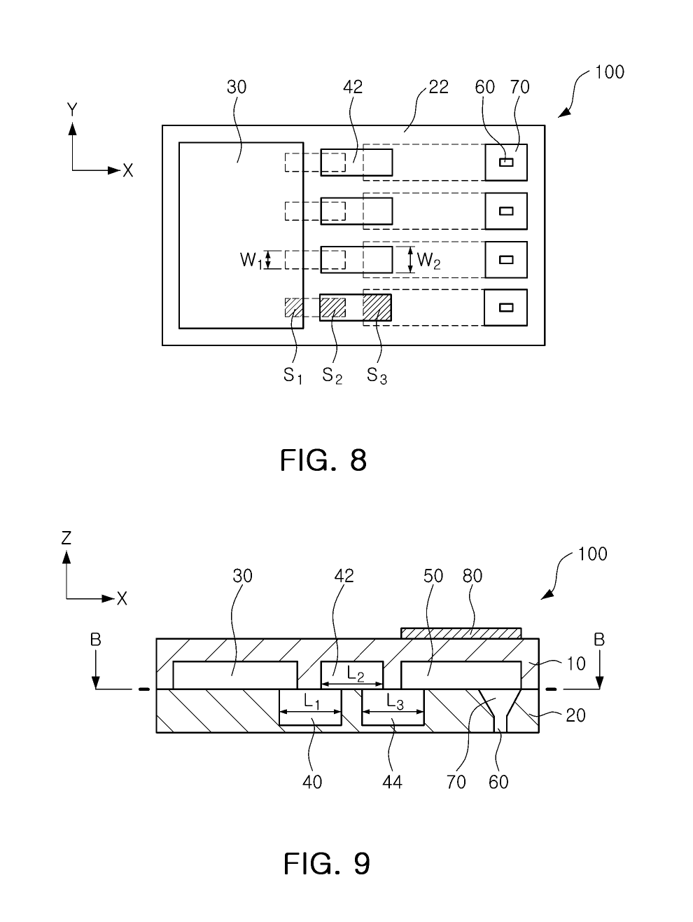

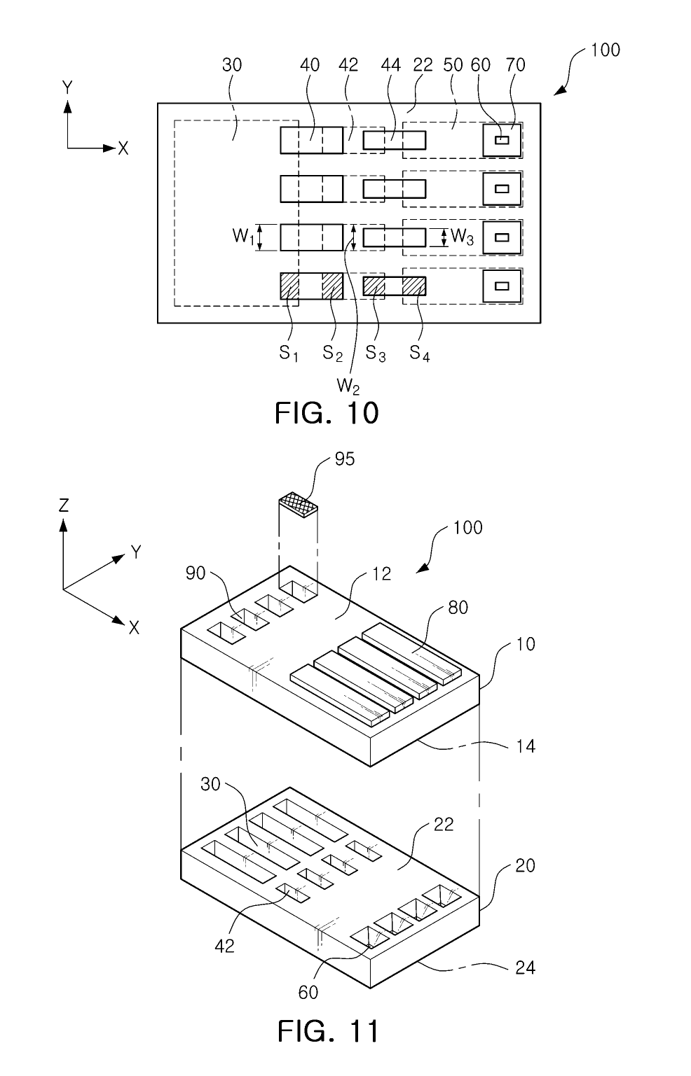

FIG. 1 is an exploded perspective view of an inkjet print head according to an embodiment of the present invention. FIG. 2 is a bottom view of a first substrate illustrated in FIG. 1. FIG. 3 is a plan view of a second substrate illustrated in FIG. 1. FIG. 4 is an assembled perspective view of the inkjet print head of FIG. 1. FIG. 5 is a cross-sectional view of the inkjet print head illustrated in FIG. 4 taken along line A-A. FIG. 6 is a view showing a coupling surface (cross-section B-B) of the inkjet print head of FIG. 5. FIG. 7 is a cross-sectional view of an inkjet print head according to another embodiment of the present invention, taken along line A-A. FIG. 8 is a view showing a coupling surface (cross-section B-B) of the inkjet print head of FIG. 7. FIG. 9 is a cross-sectional view of an inkjet print head according to another embodiment of the present invention, taken along line A-A. FIG. 10 is a view showing a coupling surface (cross-section B-B) of the inkjet print head of FIG. 9. FIG. 11 is an exploded perspective view of an inkjet print head according to another embodiment of the present invention.

An inkjet print head 100 according to an embodiment of the present invention will be described with reference to FIGS. 1 through 6.

The inkjet print head 100 according to the present embodiment of the invention may include a first substrate 10 and a second substrate 20, and may further include an actuator 80.

The first substrate 10 may be a portion of the inkjet print head 100, and may be formed of a mono-crystalline silicon substrate. However, according to necessity, the first substrate 10 may also be formed of a silicon on insulator (SOI) substrate. In this case, the first substrate 10 may have a stack structure in which a silicon substrate and a plurality of insulating members are stacked.

The first substrate 10 may include first restrictors 40, pressure chambers 50, and actuators 80. Specifically, the actuators 80 may be formed on a first surface 12 of the first substrate 10, and the first restrictors 40 and the pressure chambers 50 may be formed in a second surface 14 of the first substrate 10. Moreover, an ink supply passage 90 may be formed in the first substrate 10. The ink supply passage 90 may extend in a thickness direction of the first substrate 10 (a Z-axis direction based on FIG. 1).

The first restrictors 40 may be formed in the second surface 14 of the first substrate 10. As illustrated in FIG. 2, the first restrictors 40 may be spaced apart from the pressure chambers 50 by a predetermined distance in an X-axis direction and arranged in a plurality of rows in a Y-axis direction. Here, the plurality of first restrictors 40 arranged in the Y-axis direction may be formed to respectively correspond to the plurality of pressure chambers 50 adjacent thereto. Meanwhile, although the four first restrictors 40 and the four pressure chambers 50 are formed in the first substrate 10 in the present embodiment of the invention, the number thereof may be increased or reduced according to necessity.

The first restrictor 40 may have a predetermined length L1 and a predetermined width W1. Here, the length L1 of the first restrictor 40 may be less than a length Lp of the pressure chamber 50, and the width W1 of the first restrictor 40 may be less than a width Wp of the pressure chamber 50. The first restrictor 40 formed as described above may adjust a flow amount of ink supplied from a manifold 30 to the pressure chamber 50.

The pressure chambers 50 may be formed in the second surface 14 of the first substrate 10. Specifically, the pressure chambers 50 may be formed to partially overlap second restrictors 42 of the second substrate 20, while overlapping nozzles 60 or buffer spaces 70. That is, when the first substrate 10 and the second substrate 20 are coupled to each other, the pressure chambers 50 may be connected to the second restrictors 42 and the nozzles 60 or the buffer spaces 70.

The pressure chamber 50 may have a predetermined volume. Specifically, the volume of the pressure chamber 50 may be equal to or greater than that of ink droplets to be ejected by a single operation of the actuator 80. Here, the former may be advantageous to a quantitative ejection of ink, and the latter may be advantageous to a continuous ejection from the inkjet print head 100.

Meanwhile, the pressure chambers 50 are be formed only in the second surface 14 of the first substrate 10 in FIGS. 1 and 5; however, the pressure chambers 50 may be formed to completely pass through the first substrate 10.

The actuators 80 may be formed on the first surface 12 of the first substrate 10. Specifically, the actuators 80 may be formed on the first surface 12 of the first substrate 10 in positions corresponding to the pressure chambers 50.

The actuator 80 may include a piezoelectric element and upper and lower electrode members. Specifically, the actuator 80 may have a stack structure in which the piezoelectric element is interposed between the upper and lower electrode members.

The actuator 80 formed as described above may extend or contract according to an electrical signal, thereby providing pressure to the pressure chamber 50.

The second substrate 20 may form the remaining portion of the inkjet print head 100, and may be formed of a mono-crystalline silicon substrate. However, according to necessity, the second substrate 20 may also be formed of a silicon on insulator (SOI) substrate. In this case, the second substrate 20 may have a stack structure in which a silicon substrate and a plurality of insulating members are stacked.

The second substrate 20 may include the manifold 30, the second restrictors 42, the nozzles 60, and the buffer spaces 70. Specifically, the manifold 30, the second restrictors 42, and the buffer spaces 70 may be formed in a first surface 22 of the second substrate 20. The nozzles 60 may be formed to vertically pass through the second substrate 20.

The manifold 30 may be formed on the first surface 22 of the second substrate 20. The manifold 30 may be extended in the Y-axis direction as illustrated in FIG. 3, and be spaced apart from the second restrictor 42 by a predetermined distance.

The manifold 30 may be formed to partially overlap the first restrictor 40. Specifically, the manifold 30 may be connected to the first restrictors 40 when the first substrate 10 and the second substrate 20 are coupled to each other.

In addition, the manifold 30 may be connected to the ink supply passage 90 of the first substrate 10. Accordingly, the manifold 30 may contain a large amount of ink, and supply the contained ink to the pressure chambers 50.

The second restrictors 42 may be formed in the first surface 22 of the second substrate 20. The second restrictors 42 may be spaced apart from the manifold 30 and the nozzles 60 by a predetermined distance in the X-axis direction and may be arranged in a plurality of rows in the Y-axis direction as illustrated in FIG. 3. Here, the plurality of second restrictors 42 arranged in the Y-axis direction may be formed to respectively correspond to the nozzles 60 adjacent thereto.

The second restrictors 42 may be formed to partially overlap the first restrictors 40 and the pressure chambers 50. Specifically, when the first substrate 10 and the second substrate 20 are coupled to each other, the second restrictors 42 may be connected to the first restrictors 40 and the pressure chambers 50. Together with the first restrictors 40, the second restrictors 42 formed as described above may form a single flow passage that is connected from the manifold 30 to the pressure chambers 50.

The second restrictor 42 may have a predetermined length L2 and a predetermined width W2. The length L2 of the second restrictor 42 may be less than the length Lp of the pressure chamber 50, and the width W2 of the second restrictor 42 may be less than the width Wp of the pressure chamber 50. The second restrictor 42 formed as described above may adjust a flow amount of ink supplied from the manifold 30 to the pressure chamber 50.

Meanwhile, the length L2 and the width W2 of the second restrictor 42 are equal to the length L1 and the width W1 of the first restrictor 40 in FIG. 3; however, the lengths L1 and L2 and the widths W1 and W2 may vary according to necessity. In addition, the second restrictor 42 may have a smaller volume than that of the first restrictor 40.

The nozzles 60 may be formed in the second substrate 20. Specifically, the nozzles 60 may extend in the thickness direction of the second substrate 20 (the Z-axis direction based on FIG. 1).

The nozzles 60 may be formed to overlap the pressure chambers 50 of the first substrate 10. Specifically, when the first substrate 10 and the second substrate 20 are coupled to each other, the nozzles 60 may be connected to the pressure chambers 50. More specifically, when the first substrate 10 and the second substrate 20 are coupled to each other, an area in which the nozzles 60 are formed may be completely included in an area in which the pressure chambers 50 are formed.

The buffer spaces 70 may be formed in the first surface 22 of the second substrate 20 and may be portions of the nozzles 60.

The buffer space 70 may be partially decreased in a direction toward the nozzle. For example, the buffer space 70 may have a form of a truncated pyramid or a truncated cone. The buffer space 70 formed as described above may facilitate the ejection of ink from the pressure chamber 50 through the nozzle 60.

The inkjet print head 100 having the above-described configuration may be formed by coupling the first substrate 10 and the second substrate 20 as illustrated in FIG. 4, and may have a cross-section and a coupling surface illustrated in FIGS. 5 and 6, respectively.

Hereinafter, the coupled structure of the inkjet print head 100 according to the present embodiment will be described with reference to FIGS. 5 and 6.

As illustrated in FIG. 5, the inkjet print head 100 according to the present embodiment may include two restrictors, i.e., the first restrictor 40 and the second restrictor 42. The first restrictor 40 may connect the manifold 30 to the second restrictor 42, and the second restrictor 42 may connect the first restrictor 40 to the pressure chamber 50.

The first restrictor 40 may have a predetermined height h1. The height h1 of the first restrictors 40 may be equal to or less than a height hp of the pressure chamber 50. When the height h1 is equal to the height hp, it may be advantageous to form the first restrictor 40 and the pressure chamber 50 in the first substrate 10 in a single process. When the height h1 is less than the height hp, ink flow back due to the first restrictor 40 may be effectively reduced.

The second restrictor 42 may have a predetermined height h2. The height h2 of the second restrictor 42 may be equal to the height h1 of the first restrictor 40. Alternatively, the height h2 of the second restrictor 42 may be equal to or less than a height hm of the manifold 30. When the height h2 is equal to the height hm, it may be advantageous to form the second restrictor 42 and the manifold 30 in the second substrate 20 in a single process. When the height h2 is less than the height hm, ink flow back due to the second restrictor 42 may be effectively reduced.

Meanwhile, as illustrated in FIG. 6, the first restrictor 40 may have a first area S1 overlapping (or being connected to) the manifold 30, and a second area S2 overlapping the second restrictor 42. In addition, the second restrictor 42 may have the second area S2 overlapping the first restrictor 40, and a third area S3 overlapping the pressure chamber 50.

Here, since the first area S1 is used as an inlet through which ink of the manifold 30 is supplied to the first restrictor 40, the first area S1 may be formed to be relatively large, as compared with the second or third area S2 or S3 in order to allow for easy supply of ink.

Also, since the third area S3 is used as an outlet through which ink supplied from the first and second restrictors 40 and 42 is supplied to the pressure chamber 50, the third area S3 may be equal to or smaller than the first area S1.

Since the second area S2 is formed to block ink flow back from the pressure chamber 50 to the manifold 30, the second area S2 may be formed to be relatively small as compared with the first area S1 or the third area S3. However, this embodiment is exemplary, and the second area S2 may be formed to have the same size as that of the first area S1 or the third area S3 according to necessity.

According to the inkjet print head 100 as configured above, the first and second restrictors 40 and 42 are formed in the different substrates, i.e., the first and second substrates 10 and 20, respectively, and thus ink flow back from the pressure chamber 50 to the manifold 30 may be effectively prevented.

In other words, the inkjet print head 100 illustrated in FIG. 5 has a structure in which ink passages are repeatedly formed in a vertical direction, and thus ink flow back may be easily prevented.

Moreover, since the manifold 30, the pressure chamber 50, and the first and second restrictors 40 and 42 overlap one another in the plurality of areas S1, S2, and S3 according to the present embodiment of the present invention, an amount of ink supplied and ink flow back may be controlled by adjusting the dimensions of the areas S1, S2, and S3.

Hereinafter, an inkjet print head 100 according to another embodiment of the present invention will be described with reference to FIGS. 7 and 8.

The inkjet print head 100 according to this embodiment is different from the inkjet print head 100 of the previous embodiment in terms of the shape of second restrictors 42.

That is, a height h2 of the second restrictor 42 may be greater than a height h1 of a first restrictor 40 as illustrated in FIG. 7, and a width W2 of the second restrictor 42 may be greater than a width W1 of the first restrictor 40 as illustrated in FIG. 8. In addition, a first area S1, a second area S2, and a third area S3 may satisfy the following conditional expression 1:

S1<S2<S3 Conditional Expression 1

The inkjet print head 100 formed as described above has a structure in which an ink flow passage is gradually widened from a manifold 30 to a pressure chamber 50, and thus ink may be easily supplied from the manifold 30 to the pressure chamber 50. On the contrary, the ink flow passage from the pressure chamber 50 to the manifold 30 is narrowed, and thus ink flow back from the pressure chamber 50 to the manifold 30 may be effectively prevented.

Hereinafter, an inkjet print head 100 according to another embodiment of the present invention will be described with reference to FIGS. 9 and 10.

The inkjet print head 100 according to the present embodiment is different from the inkjet print head 100 of the previous embodiments in that third restrictors 44 are further provided.

According to the present embodiment, a manifold 30, second restrictors 42, and pressure chambers 50 may be formed on a second surface of a first substrate 10. First restrictors 40, the third restrictors 44, nozzles 60, and buffer spaces 70 may be formed on a first surface of a second substrate 20.

Also, as illustrated in FIG. 10, the inkjet print head 100 according to the present embodiment may include a first area S1 in which the manifold 30 and the first restrictor 40 overlap each other, a second area S2 in which the first restrictor 40 and the second restrictor 42 overlap each other, a third area S3 in which the second restrictor 42 and the third restrictor 44 overlap each other, and a fourth area S4 in which the third restrictor 44 and the pressure chamber 50 overlap each other.

Here, the third area S3 may have a relatively small dimension as compared with those of the other areas S1, S2, and S4. Consequently, ink flow back from the pressure chamber 50 toward the manifold 30 may be effectively prevented. However, the other areas S1, S2, and S4 may have the same dimensions.

In addition, the third restrictor 44 may have a smaller width than a width W1 of the first restrictor 40 and a width W2 of the second restrictor 42 as illustrated in FIG. 10. However, according to necessity, the width W1 of the first restrictor 40 or the width W2 of the second restrictor 42 may be set to be smaller than the width of the other restrictor. Also, the third restrictor 44 may have a smaller volume than that of the first restrictor 40.

The inkjet print head 100 configured as described above includes the plurality of restrictors 40, 42, and 44, and thus ink flow back from the pressure chamber 50 to the manifold 30 may be further effectively prevented.

In addition, according to the present embodiment of the present invention, as the manifold 30 and the pressure chamber 50 having a relatively large volume are formed in the first substrate 10, a thickness of the second substrate 20 may be less than that of the first substrate 10, and thus heights of the first and third restrictors 40 and 44 may be easily adjusted.

Hereinafter, an inkjet print head 100 according to another embodiment of the present invention will be described with reference to FIG. 11.

The inkjet print head 100 according to the present embodiment of the invention is different from the inkjet print head 100 of the previous embodiments in terms of a manifold 30 and an ink supply passage 90. That is, the inkjet print head 100 may include a plurality of manifolds 30 and a plurality of ink supply passages 90 as illustrated in FIG. 11.

The ink supply passages 90 may be formed in a first substrate 10, and may be arranged at predetermined intervals along a Y-axis in the same arrangement as that of the pressure chambers 50. The number of rows in the arrangement and intervals between the ink supply passages 90 may be the same as those of the pressure chambers 50 formed in a second substrate 20.

The manifolds 30 may be formed in the second substrate 20, and may be arranged at predetermined intervals along the Y-axis in the same arrangement of the ink supply passages 90. The number of rows in arrangement and intervals between the manifolds 30 may be the same as those of the ink supply passages 90 formed in the first substrate 10.

In the above-described structure, since each pair of the pressure chamber 50 and the nozzle 60 corresponds to each pair of the ink supply passage 90 and the manifold 30, crosstalk caused due to ink flow back may be minimized.

In addition, in this structure, ink may be individually supplied to each of the pressure chambers 50, such that ink may be ejected precisely, thereby achieving high-resolution printing quality.

Meanwhile, according to the present embodiment of the invention, a filter member 95 may be further formed in the ink supply passage 90 as illustrated in FIG. 11. Accordingly, foreign objects contained in ink may be removed.

Accordingly, according to the present embodiment of the invention, jam of the nozzle 60 by foreign objects may be prevented.

As set forth above, according to embodiments of the present invention, transfer of pressure generated in a pressure chamber to a manifold may be prevented effectively, thereby reducing a degradation in printing quality due to crosstalk.

While the present invention has been shown and described in connection with the exemplary embodiments, it will be apparent to those skilled in the art that modifications and variations can be made without departing from the spirit and scope of the invention as defined by the appended claims.

What is claimed is:

1. An inkjet print head, comprising:
a first substrate in which a first restrictor and a pressure chamber are formed; and
a second substrate in which a manifold, a second restrictor, and a nozzle are formed,
wherein the first restrictor is connected to the manifold and the second restrictor, and
the second restrictor is connected to the first restrictor and the pressure chamber.

2. The inkjet print head of claim 1, wherein the first restrictor has a greater length than the second restrictor.

3. The inkjet print head of claim 1, wherein the first restrictor has a greater width than the second restrictor.

4. The inkjet print head of claim 1, wherein the first restrictor and the second restrictor have smaller widths than the pressure chamber.

5. The inkjet print head of claim 1, wherein when the first substrate and the second substrate are coupled to each other, a first area in which the first restrictor and the manifold overlap each other is greater than a second area in which the first restrictor and the second restrictor overlap each other.

6. The inkjet print head of claim 5, wherein when the first substrate and the second substrate are coupled to each other, the second area is smaller than a third area in which the second restrictor and the pressure chamber overlap each other.

7. The inkjet print head of claim 1, wherein when the first substrate and the second substrate are coupled to each other, a second area in which the first restrictor and the second restrictor overlap each other is smaller than a third area in which the second restrictor and the pressure chamber overlap each other.

8. The inkjet print head of claim 1, wherein the first restrictor has a greater volume than the second restrictor.

9. The inkjet print head of claim 1, wherein the second substrate has a buffer space formed therein, the buffer space connecting the pressure chamber to the nozzle.

10. An inkjet print head, comprising:
a first substrate in which a manifold, a second restrictor, and a pressure chamber are formed; and
a second substrate in which a first restrictor, a third restrictor, and a nozzle are formed,
wherein the first restrictor is connected to the manifold and the second restrictor, and
the third restrictor is connected to the second restrictor and the pressure chamber.

11. The inkjet print head of claim 10, wherein the first restrictor has a greater length than the second restrictor.

12. The inkjet print head of claim 10, wherein the first restrictor has a greater width than the second restrictor.

13. The inkjet print head of claim 10, wherein the first restrictor, the second restrictor, and the third restrictor have smaller widths than the pressure chamber.

14. The inkjet print head of claim 10, wherein when the first substrate and the second substrate are coupled to each other, a first area in which the first restrictor and the manifold overlap each other is greater than a second area in which the first restrictor and the second restrictor overlap each other.

15. The inkjet print head of claim 14, wherein when the first substrate and the second substrate are coupled to each other, the second area is greater than a third area in which the second restrictor and the third restrictor overlap each other.

16. The inkjet print head of claim 14, wherein when the first substrate and the second substrate are coupled to each other, the first area is greater than a fourth area in which the third restrictor and the pressure chamber overlap each other.

17. The inkjet print head of claim 10, wherein when the first substrate and the second substrate are coupled to each other, a second area in which the first restrictor and the second restrictor overlap each other or a third area in which the second restrictor and the third restrictor overlap each other is smaller than a fourth area in which the third restrictor and the pressure chamber overlap each other.

18. The inkjet print head of claim 10, wherein the first restrictor has a greater volume than the second restrictor or the third restrictor.

19. The inkjet print head of claim 10, wherein the third restrictor has a greater volume than the second restrictor.

20. The inkjet print head of claim 10, wherein the second substrate has a buffer space formed therein, the buffer space connecting the pressure chamber to the nozzle.
